(19) United States
(12) Patent Application Publication
(10) Pub. No.: US 2013/0138529 A1
(43) Pub. Date: May 30, 2013

(54) SYSTEM AND METHOD FOR REMOTELY CUSTOMIZED ORDERING COMMODITY'S DESIGN AND MANUFACTURE COMBINED WITH A NETWORK

(71) Applicant: I-Shun Hou, Taipei City 116 (TW)

(72) Inventor: I-Shun Hou, Taipei City 116 (TW)

(21) Appl. No.: 13/806,222

(22) PCT Filed: Aug. 27, 2010
(86) PCT No.: PCT/CN10/01303

§ 371 Date: Dec. 21, 2012

(51) Int. Cl. G06Q 30/06

(52) U.S. Cl. CPC G06Q 30/0621
USPC 705/26.5

(57) ABSTRACT

A system and method for remotely customized ordering commodity's design and manufacture combined with a network are provided by the present invention. The method includes: a client computer manipulates a product design manipulation interface to access data in a data server and performs commodity's design; a transaction platform pays directly to form an order; an ERP automated production schedule system issues the production instructions and the operation guidance automatically utilizing the order; CAD/CAM automated production modules perform production; a logistics distribution system directly delivers commodities to consumers. Through the above-mentioned method, low-cost operation is really realized, and a kind of new business model of zero inventory is achieved by make-to-order.

### CROSS-REFERENCE TO RELATED APPLICATIONS

This application is a continuation of Serial No. PCT/CN2010/001303, filed on 27 Aug. 2010, and entitled SYSTEM AND METHOD FOR REMOTELY CUSTOMIZED ORDERING COMMODITY'S DESIGN AND MANUFACTURE COMBINED WITH A NETWORK.

### BACKGROUND OF THE INVENTION

1. Field of the Invention

The present invention is related to a system of customized Internet ordering, in particular, to a system and method for remotely customized ordering commodity's design and manufacture combined with a network that produces customized products responsive to an Internet ordering through ERP which is automatically linked with CAD/CAM.

2. Description of Related Art

With increasingly developed technology, consumers may not be content with the off-the-shelf products anymore. On the contrary, the consumers may wish to add their own thoughts or design elements onto the product of existing basic type. Therefore, they may create their personal style and unique innovative products. In addition to the customized matters seemed to content the consumers, the customization of products may be one of the ways to increase market competitiveness.

The present customized method allowing the consumers to design their own styles is still depending on the consumers' thoughts, and then delivering the design aspects to the manufacturer. However, this method still needs to wait for the consumers' designs, and may require any communication with each other. The final decision of the design may require molding to manufacture a customized product after the mutual communications and discussions. In general, these communications and discussions spend months to make the decision. Not only the conventional customization spends time to go, but also the cost of customized process is more expensive than existing product since the number of customized products is few. The customized process may not be affordable to the average people.

Furthermore, there still exists a much cheaper customized process for the manufacturer to provide the various design elements for the same series of products. Those provided design elements allow user to have the product with different design distinct from others. The products with few different design elements are generally limited-edition goods. By this business mode, the consumer may buy one special goods at lower prices. However, this type of customized process may not truly be the real customization and its core value.

### SUMMARY OF THE INVENTION

One of the objectives of the present invention is to overcome the existing drawbacks of product described above. Provided is a system for remotely customized ordering commodity's design and manufacture combined with a network, and a method for the same. In the conventional art, system for mass production and the system for customizing production are two conceptually different and competitive systems, and each of them has its unique advantage. The present invention successfully integrates advantages of these two systems. According to an embodiment of the present invention, it is able to implement the production and distribution of the customized products using the technology of mass production. Furthermore, the invention aims to using similar cost and time to accomplish the manufacture and product delivery. Also, the CAD modularization product design and CAM modularization manufacture design incorporated in the claimed system achieves fast module-exchanged production. The system preferably employs the network communication technology to raise the speed and efficiency to implement the manufacture, and further reduce production cost and meet the customer's need.

One further objective of the present invention is to allow user to remotely design the customized product by himself and submit order through the professional DIY service and website in the system for remotely customized ordering commodity's design and manufacture combined with a network.

In one further objective of the present invention, provided is the system being associated with the ERP system for automatically assigning production and conducting operation. Large number automations are applied to the process of production, and make the cumbersome and complex operations much easier.

One more objective of the present invention is to provide the claimed system with remote customization to constitute a flexible and automated ERP system with application of network technology and strategy management. Therefore, the system in accordance with the present invention is able to implement fast and varied product and service with deep customization, and also content the large requirements of customized production.

Furthermore, one feature of the present invention of the claimed system and method is to implement low-cost customized production.

Still further, one of the objectives of the claimed system and method of the present invention is to apply a computer aided design/manufacturing (CAD/CAM) which achieves a fast module-exchanged production in order to raise timeliness, and also make the appearance of the product look nice, more sophisticated production process, as well as raising product quality and life time.

One more objective of the present invention is to provide the claimed system and method in combination with remote customization for achieving fast production in accordance with orders made by the clients even requirement of mass production in condition for without stock.

The above described objectives are exemplarily embodied by the following aspects.

One of the characteristics of the claimed system and method in combination with remote customization is to apply the constitution of a data server and a plurality of client-end computers, and the system includes:

the data server, used to store the various design data modules provided for clients to select with; a product design manipulation interface, built in a network server, used to access the data server and the linked client-end computer; an ERP automated schedule system, applying network server to automatically issue the production instructions and operation guidance; a CAD/CAM automated production module, used to receive the production instructions correlated with the ERP automated schedule system and perform production processing.

The above-referenced system for remotely customized ordering commodity's design and manufacture combined with a network further includes, after completing the product design operating interface, a transaction platform provided for clients to conduct payment in compliance with a payment agreement mechanism under a predetermined mode.

Under the predetermined mode, the system incorporates one of the schemes including Internet trading, postal remittance, and credit card transfer.

The above-referenced system for remotely customized ordering commodity's design and manufacture combined with a network further includes an inquiring module provided for the consumers to inquire the progress of logistics distribution on a website through the corresponding links to the ERP automated schedule system.

In the claimed system, the design data module of the mentioned data server at least includes a plurality of style data units, font data units, icon data units and the accessory data units.

In the claimed system, the ERP automated schedule system at least includes an order management server used for transferring the client's order to the product order, and a code generator for generating the unique bar code.

In the claimed system in combination with remote customization, the product design manipulation interface at least includes a selection module, provided for the client-end computer to select one product style and at least one icon from the data server via a network server.

The system includes an edition module, with respect to the selected product style and icon, which allows clients to perform customized editing and text editing for the desired appearance.

The system includes an order module provided for the client-end computer to make the order when the product has been completed by the edition module.

The method for remotely ordering customized commodity's design and manufacture combined with a network in accordance with the present invention is characterized that when the method is applied to the client end and the manufacturer through the ERP automated schedule system, and the method includes:

(a) logon a website, in which a client-end computer is connected to a network server over Internet for accessing the data stored in the data server, and an operating interface is provided for a user to conduct a product design;

(b) designing a customized product by yourself (DIY) through a style data unit, a font data unit, an icon data unit, and an accessory data unit in the data server;

(c) in a transaction platform, the client paying the customized product under a predetermined mode in compliance with a payment agreement mechanism;

(d) outputting order, through an order management server, when the design of customized product is completed;

(e) by a code generator, generating a unique bar code corresponding to the output order;

(f) a CAD/CAM automated production module provided for receiving an instruction of ERP automated scheduling for scheduling the order to an automated production process, therefore the production task is therefore assigned and then the production is completed; and

(g) logistics distributing for fast distributing the product to the client by a distributor.

The above-described both order output and the code generation are in the ERP automated scheduling process that is depicted in the claimed method in combination with remote customization.

In one further embodiment, the method further includes a step (h) providing an inquiring module through the corresponding links in the ERP automated schedule system, and that allows the client to inquire the progress of logistics distribution on the website.

The claimed system and method is advantaged that the above-described objectives are suitable to the constitution of the at least one data server and the client-end computers, and the system is as follows.

The system includes a data server that is used to store various design data modules provided for clients to select with. The design data module includes at least one style data unit, font data unit, icon data unit, and accessory data unit.

The system includes a product design manipulation interface that is built in a network server. The product design manipulation interface is served for accessing the data server and link to the plurality of client-end computers. Further, the product design manipulation interface includes a selection module allowing the client-end computer to select one product style and at least one icon from the data server through a network server. According to the selected product style and icon, an edition module is served to perform customization and text editing for appearing the required appearance. An order module is also included for the client-end computer to make the order through an order management server when the design has been completed.

An ERP automated schedule system is also included in the system. The ERP automated schedule system is connected with the network server, and provided to issue the production instruction and operation guidance. The ERP automated schedule system at least includes an order management server for transferring the client's order, and a code generator for generating the unique bar code.

Further, a CAD/CAM automated production module is included. The CAD/CAM automated production module is used to receive the production instruction related to the ERP automated schedule system, and to perform production processing. Through the ERP automated schedule system, a laser cutting, laser engraving, CNC machining, molding, or vacuum forming may be incorporated to completing the customization.

In addition to the above-described framework, through a specific payment agreement mechanism under a predetermined mode and the links to the ERP automated schedule system, the consumers are allowed to inquire the production progress on the website.

The following steps are introduced to the objectives made by the framework for implementing the mass production.

In step (a), the step in the method is to logon a website, in which a client-end computer is connected to a network server over Internet for accessing a data server, and an operating interface is provided for a user to conduct a product design.

In step (b), the step in the method is to design a customized product by yourself through a style data unit, a font data unit, an icon data unit, and an accessory data unit in the data server.

In step (c), in a transaction platform, the method is provided for the client to pay the customized product under a predetermined mode in compliance with a payment agreement mechanism.

In step (d), the step in the method is to output order through an order management server for the completed customized product.

In step (e), the step in the method is to generate a unique bar code corresponding to the output order by a code generator.

In step (f), a CAD/CAM automated production module in the system is used to receive an instruction of ERP automated scheduling for scheduling the order to an automated production process so as to automatically assign production task, then completing the production through a production process.

In step (g), the method conducts logistics distributing for distributing the product to the client by a distributor when the customized product is completed.

Through the benefit made by the above steps, the claimed method is sufficient to overcome the drawbacks in the conventional manufacturing process. The drawbacks are such as high cost manufacture, long time to make, and enough stock is necessary for the need. It is important to be noted that the conventional technology has no ability to handle the orders to the small amount of customized products, and fast delivery.

The following five advantages are made by the claimed system for the innovative enterprises.

Firstly, the invention brings product innovation since the product customization makes the consumer to be unique and creates the values rather than the conventional mass production line. The invention is committed to implement the personalization for the customers, especially the top-class people seeking his extraordinary taste. The invention successfully contents the discerning people to have his unique possession, and unique quality of the product. The innovative product should have a certain characteristics that easily make distinct from the ordinary products because of its lively image, unique characteristics, and occupation of an appropriate position to the customers.

Secondly, the invention creates an innovative process since it incorporates an ERP automated schedule system that allows issuing the production instruction and operation guidance. The invention is capable of handling the mass automatic procedures. The invention also simplifies the flow of production, reduces the cost, and also fast responding to the customer's need.

Thirdly, the invention implements technical innovation. In detail, one product owns a mold that adopts the fast module-exchanged production such as technologies of CAD modularization product design and CAM modularization process design. The invention embodies the low-cost customization product while it incorporates the deep mold customization and innovative technologies.

Fourthly, the invention provides marketing strategy innovation. The claimed system and method make breakthrough of the traditional technology. One of the innovative business models is to allow the customers to make the order over Internet, combine the user interface for DIY manipulation of production creation, and deep and fast ordering experience. It creates the chance to spread the business model over the world.

Fifthly, the invention makes business strategy innovation. The business strategy of the business model made by the invention essentially makes the production based on the orders, and it allows zero inventory. The invention also reduces the risk of transaction since it requires the customers to pay in advance, and effectively reduces capital turnover and operating costs. The system provides competitive value to the customers since it effectively integrates the internal and external resources. The invention keeps the enterprises competitive advantage since it avoids the price competition with other competitors.

### BRIEF DESCRIPTION OF THE DRAWINGS

The accompanying drawings which are incorporated in and which constitute a part of this specification illustrate several exemplary constructions and procedures in accordance with the present invention and, together with the general description of the invention given above and the detailed description set forth below, serve to explain the principles of the invention wherein:

FIG. 1 is a block diagram describing a preferred embodiment of the present invention;

FIG. 2 shows a flow chart illustrating one of the embodiments of the present invention;

FIG. 3 shows a block diagram of a data server in accordance with the present invention;

FIG. 4 shows a flow chart illustrating operating process in one embodiment of the present invention.

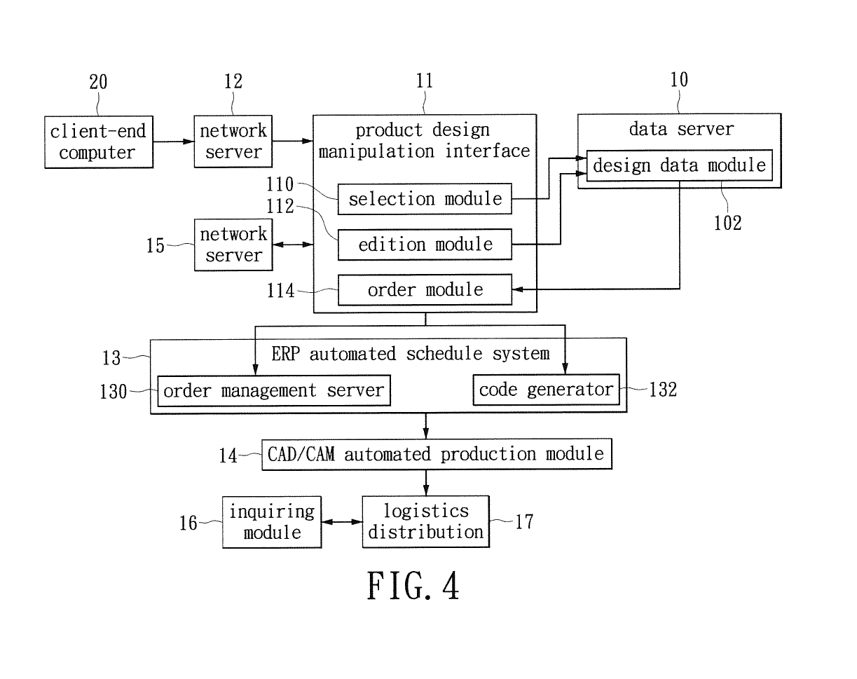

### DETAILED DESCRIPTION OF THE PREFERRED EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

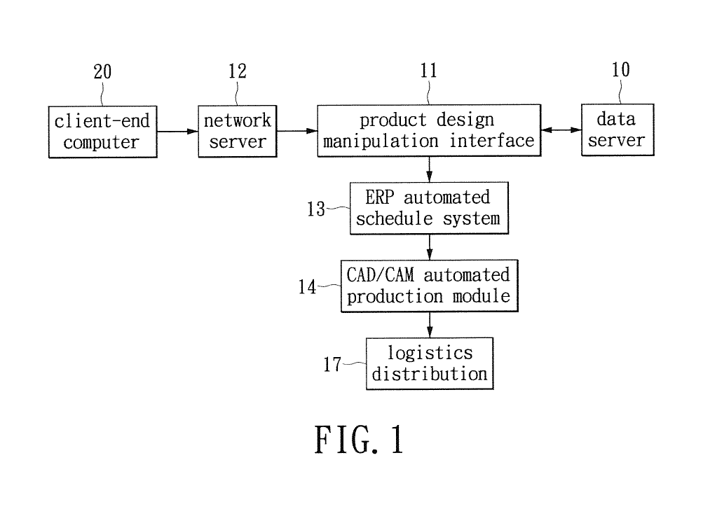

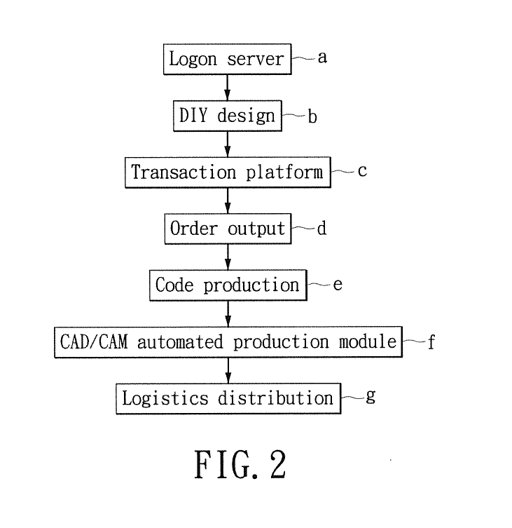

References are made to FIGS. 1, 2, and 3 that show the preferred embodiments of the present invention. A system and method for remotely customized ordering commodity's design and manufacture combined with a network for the same are disclosed, and the system is exemplarily a computer-implemented system. The system at least incorporates a data server 10 and a plurality of client-end computers 20 that form a framework for implementing remote customization.

The data server 10 (having computer-readable medium) stores various design data modules provided for the clients to select with. The each design data module includes a plurality of style data units 1020, font data units 1022, icon data units 1024, and accessory data units 1026.

The product design manipulation interface 11 is built over a network server 12 for accessing the data server 10, and linking to the client-end computers 20. In addition, the product design manipulation interface 11 at least provides a computer or processor-executable selection module 110 which provides the client-end computer 20 to select one product style and at least one icon from the data server 10 through the network server 12. A computer or processor-executable edition module 112 is further included in the interface 11 for processing customization editing and text editing with respect to the selected product style and icon(s). The edition module 112 allows appearing the appearance of the product. A computer or processor-executable order module 112 is included to serve the client-end computer 20 to make an order of the customized product according to the product designed by the edition module 112.

An ERP automated schedule system 13 is included in the system, and exemplarily is a computer-implemented system. The system 13 applies the network server 12 to issue the production instructions and operation guidance automatically. The ERP automated schedule system 13 at least includes a computer or processor-executable order management server 130 used for transferring the customer's order to the product order, and a computer or processor-executable code generator 132 used for generating the unique code such as a bar code.

A CAD/CAM automated production module 14 included in the system may be a computer or processor-executable module. The module 14 receives the production instruction associated to the ERP automated schedule system 13, and accordingly performs production processing. Through the front-end ERP automated schedule system 14, the preferred technologies such as a laser cutting, laser engraving, CNC machining, molding, or vacuum forming may be incorporated to completing the customization.

In addition to the above described framework, the system further provides a transaction platform 15 for conducting the payment in accordance with a payment agreement mechanism under a predetermined mode. The system also makes more perfect since it uses an inquiring module 16 with the links of the ERP automated schedule system 13 to provide the customer to inquire progress of logistics distribution 17 on a computer-implemented website. The inquiring module 16 is preferably a computer or processor-executable module.

The framework in accordance with the present invention is preferably using the following steps to make the mass customized production.

In a first step in the method, the customer uses a client-end computer 20 to logon a website. Over Internet a network server 12 and a product design manipulation interface 11 are connected with the client-end computer 20. The connections allow the computer 20 to access the data server 10.

Next, the system allows the customer to conduct the design of customized product by himself (DIY). The customization requires a style data unit 1020, a font data unit 1022, an icon data unit 1024, and an accessory data unit 1026 in the data server 10.

Third, a transaction platform with a payment agreement mechanism under a predetermined mode is provided for the customer to make the payment.

Then the step in the method is to output an order. An order management server 130 is served to make an order when the customized (personalized) product has been completed.

The next step in the method is to generate a unique code. The code generator 132 is used to generate a unique bar code.

A CAD/CAM automated production module is used to receive the instructions from the ERP automated schedule system 13. The related order is then scheduled to the automated production process, and automatically instructing a product task. The production is completed when the production processing is performed.

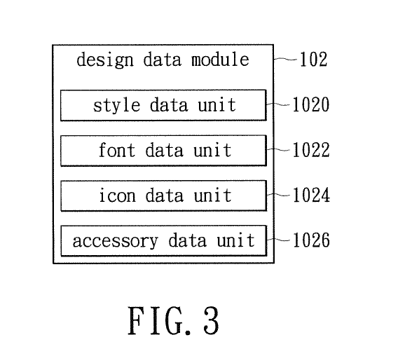

After that, a logistics distribution is performed. The step in the method is to deliver the customized product to the client by a distributor. Through the claimed system and method, the customer may use the client-end computer 20 to customize the product on a network server 12 over Internet. On the network server 12, a product design manipulation interface 11 is provided for allowing the customer to make the customization by a design data module 102 of the data server 10. The customization is made by the design data module 102 which at least includes a plurality of style data units 1020, font data units 1022, icon data units 1024 and accessory data units 1026, as shown in FIG. 3. Through the items or/and materials recorded in the mentioned plural data units, the customer is allowed to make the selection of the style and icon(s) by the computer or process-executable selection module 110 on the product design manipulation interface 11. According to the selected items or materials, the edition module 112 is served to perform the corresponding customization editing and text editing. Therefore, the customer is allowed to have his personalized product according to his preference based on the selections.

When the production has been completed, the transaction platform 15 under a predetermined mode is served to pay the order in compliance with a payment agreement mechanism. The predetermined mode is such as the Internet transaction, postal remittance and credit card transfer. The customer uses the client-end computer 20 to make an order of the customized product made by the edition module 112 to the order management server 130 by the order module 114. It is noted that the modules pertain to the final result may be the software-based modules which are made by the computer or processor-executable codes.

The order management server 130 is applied to the network server 12. The server 130 acquires the orders form the ERP automated schedule system 13, and automatically transfers order corresponding to the product to the product order. The server 130 also issues the production instruction and the operation guidance. The code generator 132 coupled to the order management server 130 is used to generate the unique code associated to the product(s) for each order. This unique code (bar code) allows the each production process to recognize the each product and its related information. The unique also allows the system to track and identify the each production.

Based on the production instruction made by the ERP system production instruction, the CAD/CAM automated production module 14 may accordingly performs the automated processing. The signals made by the client's design through the system may be transferred to the digital data by the CAD (Computer aided design). Then the CAM (Computer aided manufacturing) is introduced to transferring the data into the customized product under the production processing by the technologies of laser cutting, laser engraving, CNC machining, molding, or vacuum forming.

To collaborate with the ERP system and the CAD/CAM technology, the product order is scheduled to the automated production process which automatically issues the production task. Through the production processing technology, the production is completed with preparation of materials, time arrangement and production instructions. The data and the progress of production may be recorded in the ERP system for the quality control operators to examine the orders and the requirements made by the customers. The ERP system records the result of examination. The ERP system afterwards may instruct the packaging, outputting the unique code and information of delivery according to the status of the production and the examination. The information may be printed onto the package of the product.

At last, when the product has been completed, passed the examination, and packaged, the ERP system automatically classifies the product and onto the shelf according to its category or order. The operators of logistics distribution 17 may merely scan the code on the package to the ERP system, and categorize the product according to the delivery area. After that, the system unifies the distribution arrangements of the products. The logistics tracking made by a logistic company may be combined with the website of the ERP system. The status of logistics may be transmitted to the ERP system automatically. Therefore the mentioned inquiring module 16 of the claimed system is provided for the customers to check and track the orders.

It is intended that the specification and depicted embodiment be considered exemplary only, with a true scope and spirit of the invention being indicated by the broad meaning of the following claims.

What is claimed is:

1. A system for remotely customized ordering commodity's design and manufacture combined with a network, comprising:
a data server, used to store various design data modules provided for clients to select with, and the each design data module includes a plurality of style data units, a plurality of font data units, a plurality of icon data units, and a plurality of accessory data units;
a network server having a product design manipulation interface provided for one or more client-end computers to access the data server through the product design manipulation interface, and the product design manipulation interface includes:
a selection module provided for customer using the client-end computer to select product style and icon;
an edition module provided for customization editing and text editing;
an order module provided for the customer using the client-end computer to make an order;
an ERP automated schedule system, adapted to the network server, used to automatically generate a production instruction and an operation guidance, further comprising an order management server for handling the order made by the order module;
a CAD/CAM automated production module, used to receive the production instruction related to the ERP automated schedule system and process production;
a transaction platform, providing a payment agreement mechanism to the consumer who uses the client-end computer, and forming the order after payment;
an inquiring module, provided for the consumer to inquire progress of logistics distribution, performing inquiry according to the logistics and tracking information of the ERP automated schedule system.

2. The system according to claim 1, characterized in that the predetermined mode is selected from Internet transaction, postal remittance and credit card transfer.

3. The system according to claim 1, characterized in that the ERP automated schedule system at least includes an order management server used to transfer the clients' requests into orders, and a coder generator used to generate unique bar code.

4. The system according to claim 1, characterized in that the order management server manages the output orders.

5. The system according to claim 4, characterized in that the code generator generates unique bar codes with respect to the output orders.

6. A method for remotely customized ordering commodity's design and manufacture combined with a network, characterized in that the method is applied to a client and a manufacturer through technology of ERP automated scheduling, comprising:
(a) a network server receiving a connection with one or more client-end computers over Internet;
(b) logon the network server providing a product design manipulation interface for accessing data in a data server, wherein the data server includes a design data module which stores a plurality of styles, fonts, icons or/and accessories provided for the consumer using the client-end computer;
(c) via the product design manipulation interface, receiving styles, fonts, icons, or/and accessories;
(d) receiving editing made by an edition module from the one or more client-computers via the product design manipulation interface;
(e) through a transaction platform, the client, made by the one or more client-end computers, paying the customized product under a predetermined mode in compliance with a payment agreement mechanism;
(f) outputting order of the product made by the edition module through an order management server of an ERP automated schedule system;
(g) the ERP automated schedule system acquiring the order, and automatically transferring the order to the product order;
(h) the ERP automated schedule system automatically issuing production instructions and operation guidance;
(i) a CAD/CAM automated production module receiving an issuance of ERP automated scheduling for scheduling the order to an automated production process so as to automatically assign production task, then completing the production through a production process.

7. The method according to claim 6, characterized in that the method further comprises:
providing an inquiring module having corresponding links to the ERP automated schedule system, used for inquiring progress of logistics distribution on the website.

8. The method according to claim 6, characterized in that the order management sever manages the output orders.

9. The method according to claim 6, characterized in that a code generator is provided to generate a unique bar code corresponding to the customized product.
